(19) United States
(12) Patent Application Publication
(10) Pub. No.: US 2009/0276221 A1
(43) Pub. Date: Nov. 5, 2009

(54) Method and System for Processing Channel B Data for AMR and/or WAMR

(76) Inventors: Arie Heiman, Rannana (IL); Benjamin Imanilov, Petah Tikva (IL)

Correspondence Address: MCANDREWS HELD & MALLOY, LTD, 500 WEST MADISON STREET, SUITE 3400, CHICAGO, IL, 60661, US

(21) Appl. No.: 12/115,111

(22) Filed: May 5, 2008

(51) Int. Cl. G10L 11/00

(52) U.S. Cl. 704/270; 704/E11.001

(57) ABSTRACT

A method and system for processing channel B data for AMR and/or WAMR may include generating one or more channel B data hypotheses for a present speech frame, if channel A data has a valid CRC and channel B data is unacceptable. Channel B data may be unacceptable, for example, due to high residual bit error rate and/or low Viterbi metric. Speech hypotheses may also be generated for the present speech frame, where each speech hypothesis may be based on a corresponding channel B data hypothesis and channel A data. A speech constraint metric may be assigned to each speech hypothesis that is compared to a previous frame speech data. The speech hypothesis that is closest to the previous frame speech data may be selected as a present speech data. The speech constraint metric may, for example, measure gain continuity and/or pitch continuity.

### CROSS-REFERENCE TO RELATED APPLICATIONS/INCORPORATION BY REFERENCE

Not Applicable

### FIELD OF THE INVENTION

Certain embodiments of the invention relate to wireless communication systems. More specifically, certain embodiments of the invention relate to a method and system for processing channel B data for AMR and/or WAMR.

### BACKGROUND OF THE INVENTION

Signals received by a receiver system may be degraded with respect to transmitted signals. Accordingly, a receiver system may utilize various methods to try to accurately re-create the transmitted signals. Various wireless transmission protocols may comprise some forms of protection, such as, for example, using cyclic redundancy check (CRC), to help the receiver system detect signal degradation. The receiver system may then determine whether the received data may be faithful to the transmitted data by, for example, comparing a calculated CRC of the received data with the received CRC.

Another method or algorithm for signal detection in a receiver system may comprise decoding convolutional encoded data, using, for example, maximum-likelihood sequence estimation (MLSE). The MLSE is an algorithm that performs soft decisions while searching for a sequence that minimizes a distance metric in a trellis that characterizes the memory or interdependence of the transmitted signal. In this regard, an operation based on the Viterbi algorithm may be utilized to reduce the number of sequences in the trellis search when new signals are received.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A method and/or system for processing channel B data for AMR and/or WAMR, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1A is a block diagram illustrating an exemplary system for processing WCDMA speech data, which may be utilized in connection with an embodiment of the invention.

FIG. 1B is a block diagram illustrating an exemplary system for processing WCDMA speech data with a processor and memory, which may be utilized in connection with an embodiment of the invention.

FIG. 2A is a block diagram illustrating a frame process block shown in FIG. 1A, in accordance with an embodiment of the invention.

FIG. 2B is a block diagram illustrating a frame process block shown in FIG. 1A, in accordance with an embodiment of the invention.

FIG. 3 is a diagram illustrating irregularity in pitch continuity voice frames, which may be utilized in association with an embodiment of the invention.

FIG. 4A is a flow diagram illustrating exemplary steps for generating speech data, in accordance with an embodiment of the invention.

FIG. 4B is a flow diagram illustrating exemplary steps for determining channel B data, in accordance with an embodiment of the invention.

### DETAILED DESCRIPTION OF THE INVENTION

Certain embodiments of the invention provide a method and system for processing channel B data for AMR and/or WAMR. Aspects of the method may comprise generating one or more channel B data hypotheses for a present speech frame if channel A data is verified to be correct via cyclic redundancy check and channel B data is unacceptable based on one or more error measurement metrics. The error measurement metrics may comprise, for example, residual bit error rate and/or Viterbi metric.

One or more speech hypotheses may also be generated for the present speech frame where each speech hypothesis may be based on a corresponding channel B data hypothesis and the channel A data. A speech constraint metric may be assigned to each of the speech hypotheses that may be compared to speech data from a previous speech frame. The speech hypothesis that may be closest to the speech data from the previous speech frame, as determined by the speech constraint metric, may be selected as a present speech data. The speech constraint metric may, for example, measure gain continuity and/or pitch continuity.

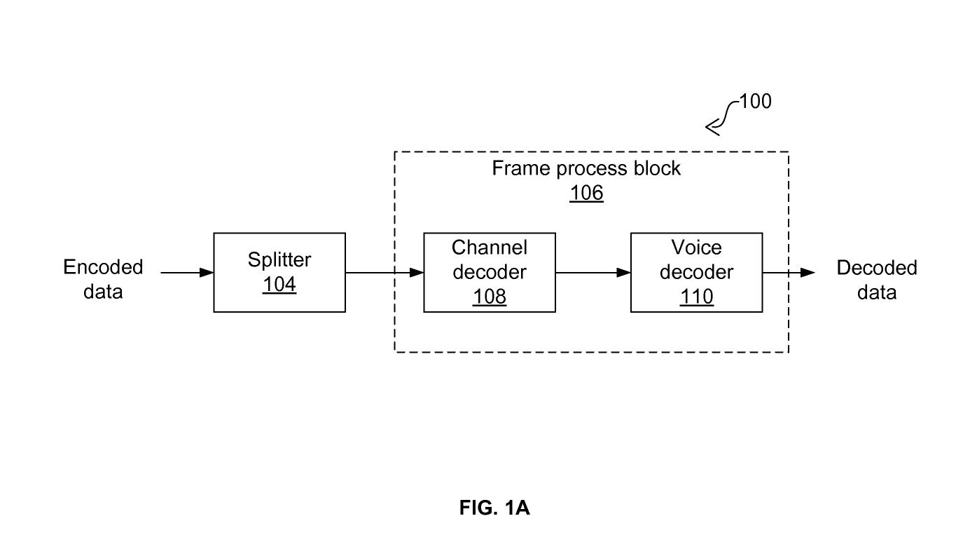

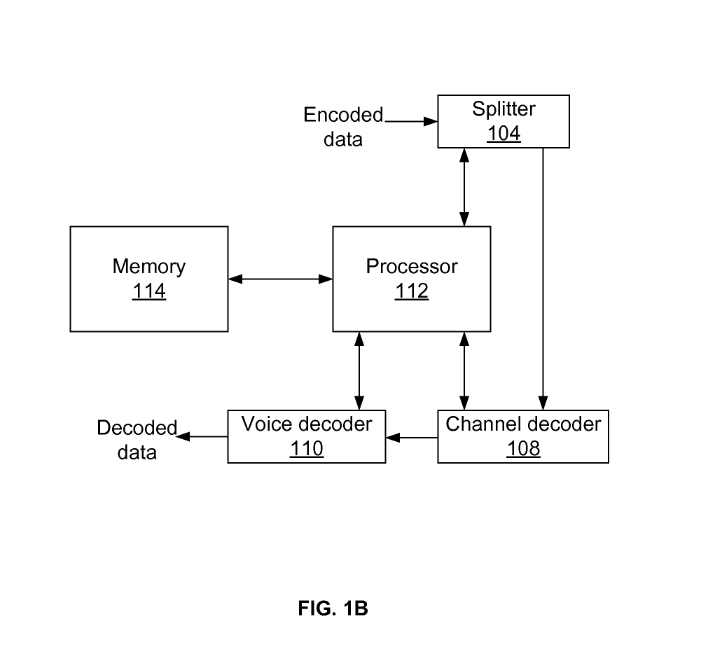

FIG. 1A is a block diagram illustrating an exemplary system for processing WCDMA speech data, which may be utilized in connection with an embodiment of the invention. Referring to FIG. 1A, there is shown a receiver 100 that comprises a splitter 104 and a frame process block 106. The frame process block 106 may comprise a channel decoder 108 and a voice decoder 110. The receiver 100 may comprise suitable logic, circuitry, and/or code that may operate as a wireless receiver. The receiver 100 may comprise suitable logic, circuitry, and/or code that may operate as a wireless receiver. The receiver 100 may utilize redundancy to decode interdependent signals, for example, signals that comprise convolutional encoded data.

The splitter 104 may comprise suitable logic, circuitry, and/or code that may enable splitting of received bits to two or three channels to form the frame inputs to the frame process block 106. The channel decoder 108 may comprise suitable logic, circuitry, and/or code that may enable decoding of the bit-sequences in the input frames received from the splitter 104. The channel decoder 108 may utilize the Viterbi algorithm to improve the decoding of the input frames. The voice decoder 110 may comprise suitable logic, circuitry, and/or code that may perform voice-processing operations on the results of the channel decoder 108. Voice processing may be adaptive multi-rate (AMR) voice decoding for WCDMA or from other voice decoders, for example. Voice processing may also be, for example, wideband AMR (WAMR).

Regarding the frame process operation of the decoder 100, a standard approach for decoding convolution-encoded data may be to find the maximum-likelihood sequence estimate (MLSE) for a bit-sequence. This may involve searching for a sequence X in which the conditional probability P(X/R) is a maximum, where X is the transmitted sequence and R is the received sequence, by using, for example, the Viterbi algorithm. In some instances, the received signal R may comprise an inherent redundancy as a result of the encoding process by the signals source. This inherent redundancy, for example, a CRC and/or continuity of some speech parameters such as pitch, may be utilized in the decoding process by developing a MLSE algorithm that may meet at least some of the physical constrains of the signals source. The use of physical constraints in the MLSE may be expressed as finding a maximum of the conditional probability P(X/R), where the sequence X meets a set of physical constraints C(X) and the set of physical constraints C(x) may depend on the source type and on the application. In this regard, the source type may be speech source type.

Physical constraints for speech applications may include, for example, gain continuity, monotonous behavior, and smoothness in inter-frames or intra-frames, pitch continuity in voice inter-frames or intra-frames, and/or consistency of line spectral frequency (LSF) parameters that are utilized to represent a spectral envelope. Gain continuity refers to changes in signal gain between successive signals that may exceed a threshold. Monotonous behavior refers to change in amplitude that is unidirectional. For example, an amplitude that increases over several frames would exhibit monotonous behavior. Smoothness refers to changes in signal characteristics between successive signals that may exceed a threshold.

FIG. 1B is a block diagram illustrating an exemplary system for processing WCDMA speech data with a processor and memory, which may be utilized in connection with an embodiment of the invention. Referring to FIG. 1B, there is shown a processor 112, a memory 114, the splitter 104, the channel decoder 108, and the voice decoder 110. The processor 112 may comprise suitable logic, circuitry, and/or code that may perform computations and/or management operations. The processor 112 may also communicate and/or control at least a portion of the operations of the splitter 104, the channel decoder 108, and the voice decoder 110. The memory 114 may comprise suitable logic, circuitry, and/or code that may store data and/or control information. The memory 114 may be adapted to store information that may be utilized and/or generated by the splitter 104, the channel decoder 108, and/or the voice decoder 110. The splitter 104, the channel decoder 108, and the voice decoder 110 may operate similarly as described with respect to FIG. 1A.

In this regard, the processor 112 may control flow of information among the memory 114, the splitter 104, the channel decoder 108, and/or the voice decoder 110. The processor 112 may also communicate, for example, status and/or commands to the memory 114, the splitter 104, the channel decoder 108, and/or the voice decoder 110.

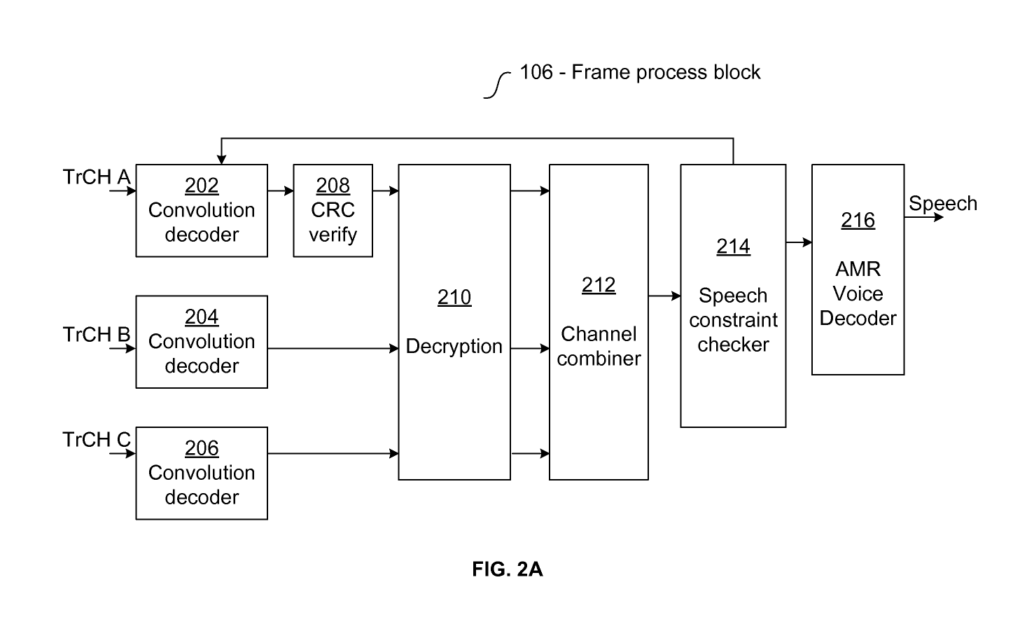

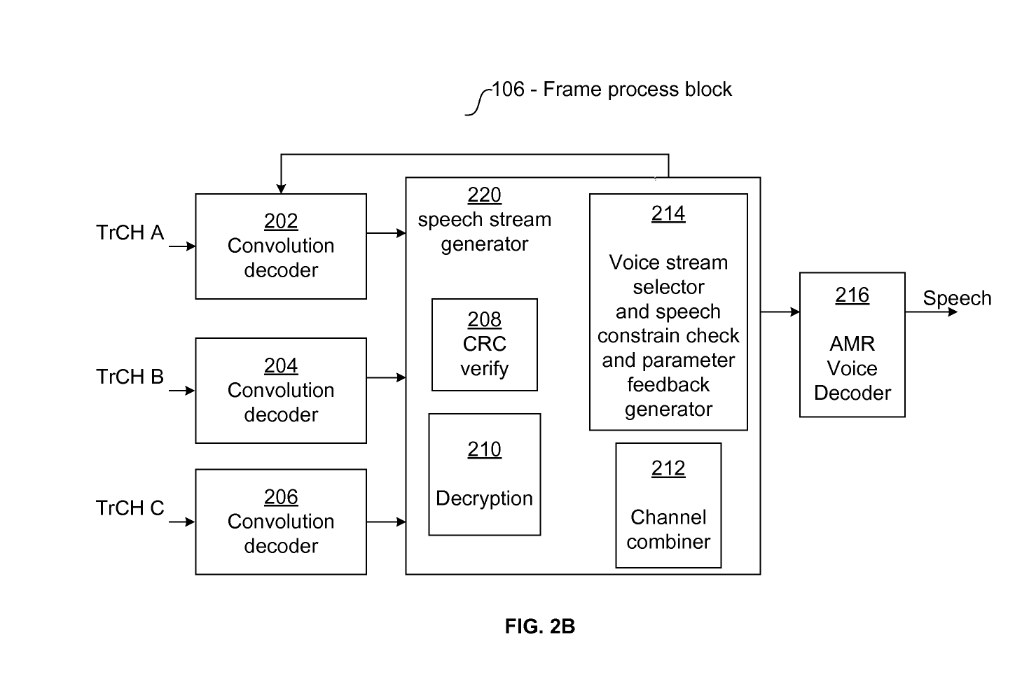

FIG. 2A is a block diagram illustrating a frame process block shown in FIG. 1A, in accordance with an embodiment of the invention. Referring to FIG. 2A, there is shown the frame process block 106 that may comprise convolution decoder blocks 202, 204, and 206, a CRC verification block 208, a decryption block 210, a channel combiner block 212, a speech constraint checker 214, and an AMR speech synthesis block 216.

The convolution decoder blocks 202, 204, and 206 may comprise suitable logic, circuitry, and/or code that may enable decoding of a data stream. The convolution decoder blocks 202, 204, and 206 may use, for example, a Viterbi algorithm and/or a modified Viterbi algorithm. The data stream may be, for example, a portion of WCDMA speech data that may have been received by the receiver 100. The speech data may have been convolution coded by a WCDMA transmitter. The received WCDMA speech data may comprise three channels, for example, A, B, and C, as required by the 3rd Generation Partnership Project (3GPP) standard. The channels A and B may have been encoded with a convolution code rate of, for example, ⅓, and the channel C may have been encoded with a convolution code rate of, for example, ½.

One embodiment of the invention may feed back information from the speech constraint checker 214 to the convolution decoder block 202. The feedback information may allow the convolution decoder block 202 to modify decoding of the channel A data stream. Other embodiments of the invention may not have the feedback loop from the speech constraint checker 214 to the convolution decoder block 202.

The CRC verification block 208 may comprise suitable logic, circuitry, and/or code that may enable verification of channel A data via a 12-bit CRC associated with channel A. The CRC verification block 208 may provide feedback information to, for example, the convolution decoder blocks 202 and 204 regarding whether channel A data may have a correct CRC.

The decryption block 210 may comprise suitable logic, circuitry, and/or code that may enable decryption of data from the CRC verification block 208 and the convolution decoders 204 and 206. The decryption may comprise, for example, exclusive-ORing the data with a decryption key. The decryption key may be, for example, the same as the encryption key that may have been used to encrypt data to be transmitted by exclusive-ORing the data to be transmitted with the encryption key.

The channel combiner block 212 may comprise suitable logic, circuitry, and/or code that may enable combining of the three channels A, B, and C to a single channel that may comprise, for example, encoded speech data. The channel combiner block 212 may build up speech parameters for testing by the speech constraint checker 214 and speech synthesis by the AMR speech synthesis block 216. The speech constraint checker 214 may comprise suitable logic, circuitry, and/or code that may enable testing speech data for compliance with speech constraints. For example, some speech constraints may comprise gain continuity, monotonous behavior, and smoothness in inter-frames or intra-frames, pitch continuity in voice inter-frames or intra-frames, and/or consistency of line spectral frequency (LSF) parameters that are utilized to represent a spectral envelope.

The AMR speech synthesis block 216 may comprise suitable logic, circuitry, and/or code that may enable decoding of the encoded speech data from the channel combiner block 212. The output of the AMR speech synthesis block 216 may be digital speech data that may be converted to an analog signal. The analog signal may be played as audio sound via a speaker.

The decoding function of the AMR speech synthesis block 216 may receive a variable number of bits for decoding. The number of bits may vary depending on the transmission rate chosen by a base station. The receiver 100 may communicate with one or more base stations (not shown), and the base stations may communicate the transmit rate to the receiver 100. Table 1 below may list the various transmission rates.

TABLE 1

| AMR coded Tx | Total # | | | |
|---|---|---|---|---|
| rate (Kbps) | of bits | CH A | CH B | CH C |
| 4.75 | 95 | 42 | 53 | 0 |
| 5.15 | 103 | 49 | 54 | 0 |
| 5.9 | 118 | 55 | 63 | 0 |
| 6.7 | 134 | 58 | 76 | 0 |
| 7.4 | 148 | 61 | 87 | 0 |
| 7.95 | 159 | 75 | 84 | 0 |
| 10.2 | 204 | 65 | 99 | 40 |
| 12.2 | 244 | 81 | 103 | 60 |

For each transmission rate, a total number of bits transmitted and number of bits for each channel may be different. For example, a transmission rate of 4.75 Kbps may transmit 95 data bits per frame. Of the 95 data bits, 49 bits may be in channel A stream and 54 bits may be in channel B stream. There may not be any bits allocated to the channel C stream. With the 12.2 Kbps transmission rate, 244 bits may be transmitted per frame. 81 bits may be in channel A stream, 103 bits may be in channel B stream, and 60 bits may be in channel C stream. Channel A may have a 12 bit CRC attached to the data, while channels B and C may not have CRC. The convolution coding rate for channels A and B may be ⅓ and the convolution coding rate for channel C may be ½.

In operation, the convolution decoder blocks 202, 204, and 206 may receive channels A, B, and C, respectively, of received speech data. Each convolution decoder may decode the respective channel A, B, or C and output a bit stream. The bit streams output by the convolution decoder 202 may be communicated to the CRC verification block 208. The CRC verification block 208 may verify that a CRC that may be part of the channel A data may be a valid CRC. The validated channel A data, which may have the CRC removed, may be communicated to the decryption block 210. The bit streams output by the convolution decoders 204 and 206 may also be communicated to the decryption block 210. The decryption block 210 may, for example, exclusive-OR the data in the bit stream with a decryption key to decrypt the data. The decrypted data for channel A, channel B, and channel C may be communicated to the channel combiner block 212.

The CRC verification block 208 may verify that the CRC that may be part of the channel A data may be a valid CRC. The validated channel A data, which may have the CRC removed, may be communicated to the channel combiner block 212. If the channel A CRC is not valid, an algorithm may comprise generating new hypotheses for channel A and further testing the CRC for those hypotheses. If one or more hypotheses can be found with correct CRC, those hypotheses may be used to determine a channel A data for use in generating speech from channel A, B, and C data. If a channel A hypothesis cannot be generated where the CRC may be valid, a bad frame indicator (BFI) flag may be asserted to indicate to, for example, the AMR speech synthesis block 216 that the current speech frame may not be valid. Accordingly, the data from channel A, and the channel B data and the channel C data associated with the invalid channel A data may not be used. If the feedback signal from the CRC verification block 208 does not indicate that channel A data may have a valid CRC, the convolution decoder block 204 may not generate channel B hypotheses for use in determining speech data.

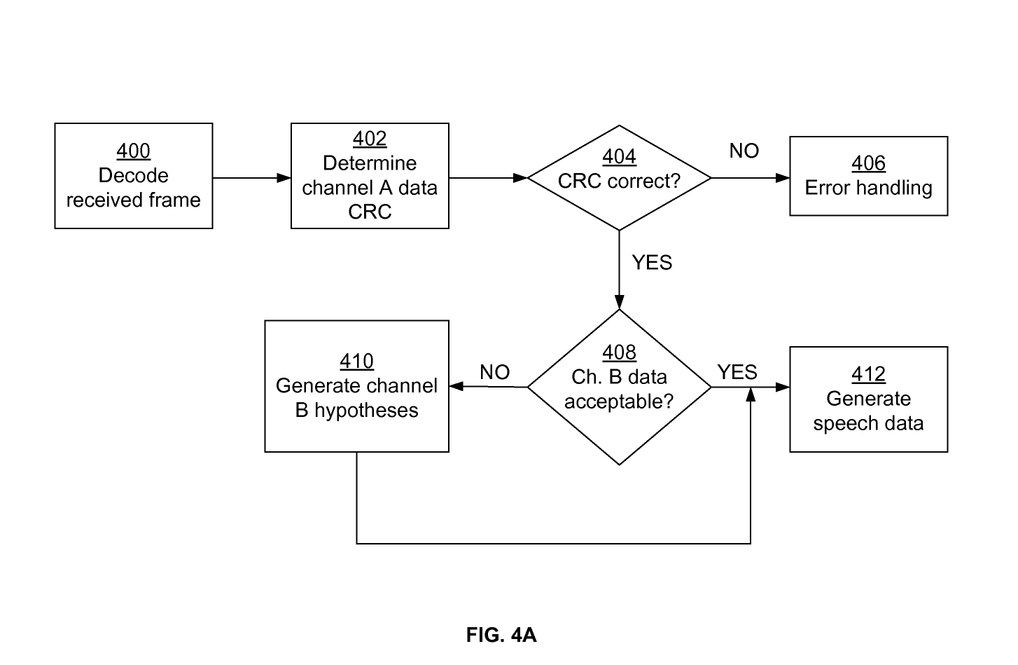

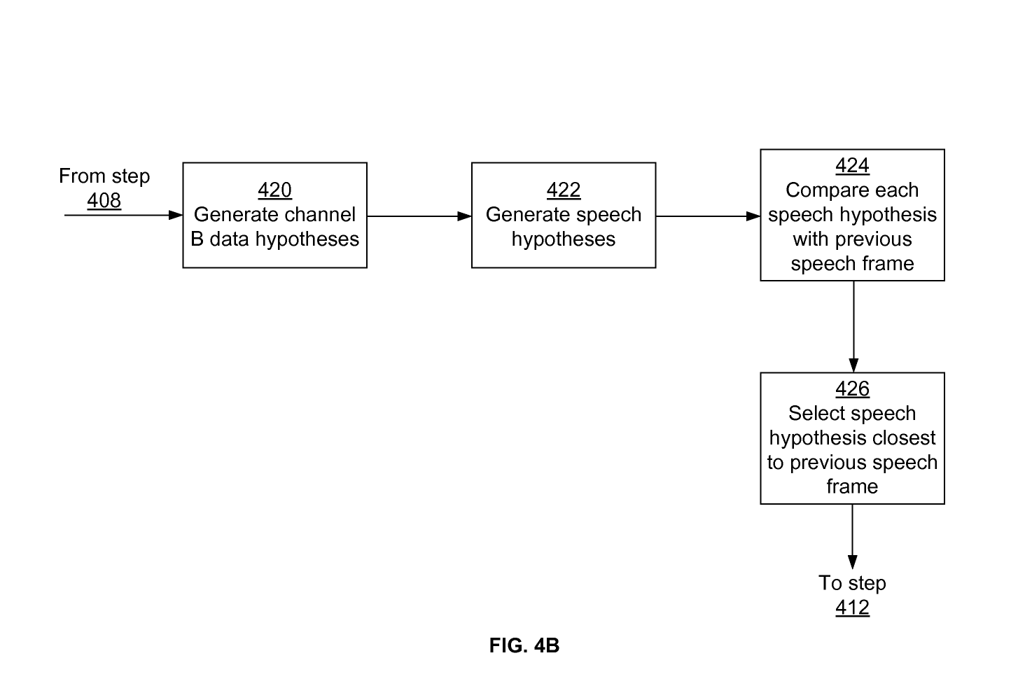

If the CRC for channel A is valid, the channel combiner block 212 may combine the data for the three channels to form a single bit stream that may be communicated to the speech constraint checker 214. Various embodiments of the invention may, for example, generate a plurality of data hypotheses for channels B and/or C to optimize voice output generation for the current speech frame. This is explained in more detail with respect to FIGS. 4A and 4B. The speech constraint checker 214 may verify that the bit stream may meet speech constraints. A bit stream may be communicated from the speech constraint checker 214 to the AMR speech synthesis block 216. The speech constraint checker 214 may also communicate a BFI flag to the AMR speech synthesis block 216. If the BFI flag is unasserted, the AMR speech synthesis block 216 may decode the bit stream to digital data that may be converted to an analog voice signal. If the BFI flag is asserted, the bit stream may be ignored.

In an embodiment of the invention, the speech constraint checker 214 may communicate a feedback signal to the convolution decoder 202. The feedback signal may be, for example, an estimated value of a current speech parameter that may be fed back to the convolution decoder blocks 202 and 204, each of which may be, for example, a Viterbi decoder and/or a modified Viterbi decoder. Other embodiments of the invention may not have a feedback loop from the speech constraint checker 214 to the convolution decoder blocks 202 and/or 204.

While an embodiment of the invention using channels A, B, and C for speech may have been described with respect to WCDMA and AMR and WAMR decoding, the invention need not be so limited. Various embodiments of the invention may also be used for other communication standards where speech data may be divided into different groups of data.

FIG. 2B is a block diagram illustrating a frame process block shown in FIG. 1A, which may be utilized in connection with an embodiment of the invention. Referring to FIG. 2B, there is shown the convolution decoder blocks 202, 204, and 206, which may be, for example, Viterbi decoders and/or modified Viterbi decoders, the AMR speech synthesis block 216, and a speech stream generator block 220. The speech stream generator block 220 may comprise the CRC verification block 208, the decryption block 210, the channel combiner block 212, and a speech constraint checker/speech stream selector block 214.

The speech constraint checker/speech stream selector block 214 may comprise suitable logic, circuitry, and/or code that may enable selection of a bit stream from a plurality of candidate bit streams. The speech constraint checker/speech stream selector block 214 may also enable estimation of a value of a current speech parameter where encoded bits may be fed back to the convolution decoder blocks 202 and/or 204, which may be, for example, the modified Viterbi decoder. However, the invention need not be so limited. For example, some embodiments of the invention may not have a feedback loop from the speech constraint checker/speech stream selector block 214 to the convolution decoder blocks 202 and/or 204.

The speech constraint checker/speech stream selector block 214 may base the selection on constraints for speech in inter-frames or intra-frames. For example, one constraint may be an amount of change allowed in volume, or gain, from one voice sample to the next. Another example of a constraint may be an amount of voice pitch change from one voice sample to the next. The constraint may be used to compare, for example, a voice sample from a present data frame with a voice sample from a previous data frame. Accordingly, the speech stream selector block 218 may output a single bit stream selected from one or more candidate bit streams.

In operation, the decoded bit streams from the convolution decoder blocks 202, 204, and 206 may be communicated to the speech stream generator block 220. The speech stream generator block 220 may decrypt the data in the speech streams and verify that the CRC is valid for channel A data. The speech stream generator block 220 may also communicate to the convolution decoder blocks 202 and 204 whether the CRC is valid for the channel A data. The speech constraint checker/speech stream selector block 214 may also feed back current speech parameter estimates to the convolution decoder blocks 202 and/or 204. The channel combiner block 212 may also combine data in each of the plurality of bit streams for channels A, B, and C to generate a plurality of bit streams. The speech constraint checker/speech stream selector block 214 may select a bit stream that may satisfy the speech constraints. The process of selecting a bit stream may be described in more detail with respect to FIGS. 4A and 4B.

Although the speech stream generator block 220 may have been described as hardware blocks with specific functionality, the invention need not be so limited. For example, other embodiments of the invention may use a processor, for example, the processor 112, for some or all of the functionality of the speech generator block 220.

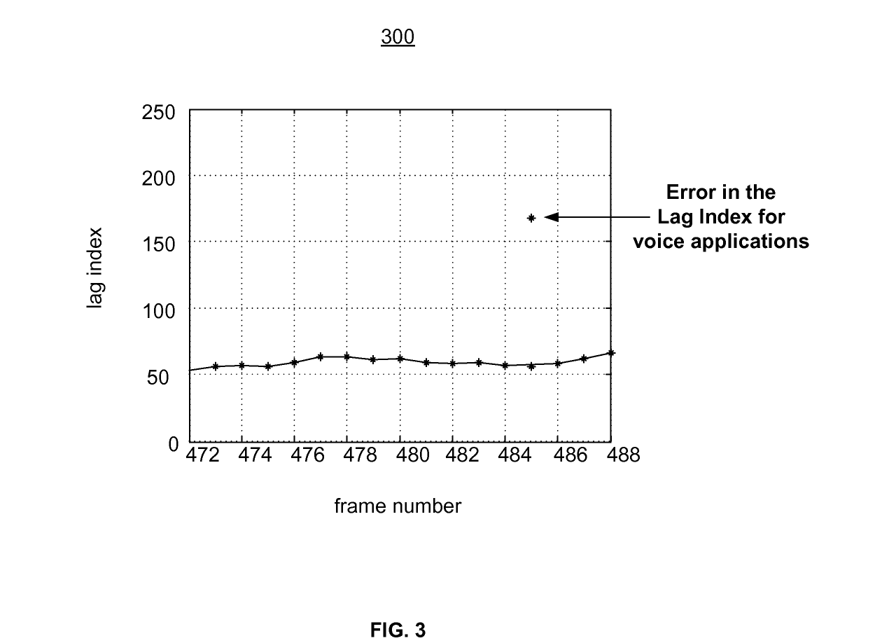

FIG. 3 is a diagram illustrating irregularity in pitch continuity voice frames, which may be utilized in association with an embodiment of the invention. Referring to FIG. 3, there is shown a graph 300 of a lag index or pitch continuity as a function of frame number with a non-physical pitch in frame 485 due to bit error. In instances where the lag index may comprise a continuity that results from physical constraints in speech, applying a physical constraint to the decoding operation of the lag index may reduce decoding errors.

For certain data formats, the inherent redundancy of the physical constraints may result from, for example, the packaging of the data and the generation of a redundancy verification parameter, such as a cyclic redundancy check (CRC), for the packetized data. In voice transmission applications, such as WAMR and/or AMR in WCDMA, the physical constraints may be similar to those utilized in general speech applications. Physical constraints may comprise gain continuity, monotonous behavior, and smoothness in inter-frames or intra-frames, pitch continuity in voice inter-frames or intra-frames, continuity of line spectral frequency (LSF) parameters and format locations that are utilized to represent speech. Moreover, WCDMA speech application may utilize redundancy, such as with CRC, as a physical constraint. For example, WCDMA application with adaptive multi-rate (AMR) coding may utilize 12 bits for CRC.

The CRC may be used, for example, for voice data in channel A, while data in channels B and C may not be protected by CRC. However, all three channels A, B, and C may be protected by convolutional coding. An embodiment of the invention may utilize the maximum-likelihood sequence estimate (MLSE) for a bit-sequence for decoding convolutional encoded data.

Regarding the frame process operation of the decoder 100, another approach for decoding convolutional encoded data may be to utilize a maximum a posteriori probability (MAP) algorithm. This approach may utilize a priori statistics of the source bits such that a one-dimensional a priori probability, p(bᵢ), may be generated, where bᵢ corresponds to a current bit in the bit-sequence to be encoded. To determine the MAP sequence, the Viterbi transition matrix calculation may need to be modified. This approach may be difficult to implement in instances where the physical constraints are complicated and when the correlation between bits bᵢ and bⱼ may not be easily determined, where i and j are far apart. In cases where a parameter domain has a high correlation, the MAP algorithm may be difficult to implement. Moreover, the MAP algorithm may not be utilized in cases where inherent redundancy, such as for CRC, is part of the physical constraints.

However, there may be instances when a received channel B data may be below an acceptance threshold, for example, where the threshold may be with respect to Viterbi algorithm and/or a residual bit error rate (RBER). Accordingly, if the received channel A data has the correct CRC, a most likely hypothesis for the channel B data may be used with the received channel A data to generate speech data.

FIG. 4A is a flow diagram illustrating exemplary steps for generating speech data, in accordance with an embodiment of the invention. Redundancy may refer to information in the data being decoded that may help to decode data. An exemplary redundancy may be a CRC associated with data. Accordingly, the CRC may be used to determine valid data. For data with corrupted bits, the redundancy of the CRC may be used to generate likely sequences of bits.

Referring to FIG. 4A, there are shown steps 400 to 408. In step 400, the received data in channels A, B, and C may be convolution decoded by, for example, the convolution decoder blocks 202, 204, and 206. In step 402, CRC may be calculated for the received channel A data by, for example, the CRC verification block 208. In step 404, the CRC verification block may determine whether the CRC is correct. If so, the next step may be step 408. Otherwise, the next step may be step 406.

In step 406, a receiver system, for example, the receiver 100, may take appropriate actions regarding the failed CRC verification. Error handling process for the failed CRC verification may be design dependent. The error handling process may comprise, for example, finding one or more new hypotheses by the convolution decoder block 202 and selecting a hypothesis with a valid CRC. The error handling process may also comprise, for example, asserting a bad frame indicator (BFI) flag to indicate to, for example, the AMR speech synthesis block 216 that the current speech frame may not be valid if a hypothesis cannot be found with a valid CRC. Generation of new hypotheses may require that those hypotheses be tested for valid CRC. Accordingly, if new hypotheses are generated, the next step may be step 406. Otherwise, if, for example, a limit on the generation of new hypotheses has been reached without a hypothesis having a valid CRC, the BFI flag may be asserted to indicate a bad frame.

In step 408, the frame process block 106 may determine whether the received channel B data may be acceptable. For example, received channel B data may be acceptable in instances where the data residual bit error rate (RBER) may be less than a threshold value and/or in instances where the data has a Viterbi metric greater than a threshold value for the Viterbi metric. The specific method of determining whether the received channel B data may be acceptable may be design dependent. In instances where the received channel B data is acceptable, the next step may be step 412. Otherwise, the next step may be step 410. In step 410, the frame process block 106 may generate channel B data hypotheses. The channel B data hypotheses may be generated by, for example, the convolution decoder block 204. Generation of channel B data hypotheses is described in more detail with respect to FIG. 4B. The next step may be step 408.

In step 412, the frame process block 106 may generate speech data using the received data in channels A, and channel B data where the channel B data may be as received or a channel B data hypothesis generated in step 410. Various embodiments of the invention may also use channel C data for generating the speech data, if channel C data is present.

FIG. 4B is a flow diagram illustrating exemplary steps for determining channel B data, in accordance with an embodiment of the invention. Referring to FIG. 4B, there are shown steps 420 to 426 that may describe in more detail the generation of channel B data hypotheses in step 410.

The step 420 may be entered as a result of channel B data being determined to be unacceptable in step 408. Accordingly, in step 420, one or more channel B data hypotheses may be generated for channel B data using, for example, a Viterbi algorithm or a modified Viterbi algorithm. A channel B data hypothesis may refer to a candidate bit-sequence that may be a likely set of bits corresponding to channel B data. The specific method for generating the channel B data hypotheses may be design dependent. The number of channel B data hypotheses generated may also be design dependent.

In step 422, a plurality of speech hypotheses may be generated, where the number of speech hypotheses may depend on, for example, the number of channel B data hypotheses. For example, in instances where the number of channel B data hypotheses to be generated is 64, then the number of speech hypotheses generated may also be 64. Each of the speech hypotheses may be generated based on, for example, the channel A data and a corresponding one of the 64 channel B data hypotheses. Various embodiments of the invention may also use channel C data, if available, to generate the speech hypotheses.

In step 424, each speech hypothesis may be compared to the speech data from the previous frame, if the previous frame was a valid frame. The best speech hypothesis for the present frame may be found by, for example, applying physical constraint test to channel B data hypothesis combined with the decoded bits of channel A and channel C. The selected speech hypothesis may be referred to as speech data for the present frame.

Some characteristic physical constraint tests that may be utilized by, for example, adaptive multi-rate (AMR) and/or wideband AMR (WAMR) coding are line spectral frequency (LSF) parameters, gain continuity, and/or pitch continuity. For the LSF parameters, some of the tests may be based on the distance between two formants, changes in consecutive LSF frames or sub-frames, and the effect of channel metrics on the thresholds. For example, the smaller the channel metric, the more difficult it may be to meet the threshold. Regarding the use of gain as a physical constraint test, the criteria may be monotonous behavior and/or smoothness or consistency between consecutive frames or sub-frames. Regarding pitch, the criteria may be the difference in pitch between frames or sub frames.

In step 426, after all of the speech hypotheses have been compared to the previous frame, the speech hypothesis that may be the most similar to the previous frame's speech data may be selected for use in the present frame. The next step may be step 412.

In instances where the previous frame comprised channel A data whose CRC could not be verified, that previous frame may not have been used. Accordingly, the speech hypotheses from the present frame may not be able to be compared to the previous frame. The speech hypotheses may then, for example, be compared to a next most recent frame that may have been valid. However, the specific error handling for cases where the previous frame may be invalid may be design dependent.

In accordance with an embodiment of the invention, aspects of an exemplary system may comprise, for example, a receiver 100 that receives at least voice data comprising channel A data and channel B data. The receiver 100 may comprise, for example, the frame process block 106 that may generate one or more channel B data hypotheses for a present speech frame, if the channel A data is verified to be correct via cyclic redundancy check and the channel B data is unacceptable based on one or more error measurement metrics. The error measurement metrics may be a measurement of, for example, residual bit error rate and/or Viterbi metric.

The convolution decoder block 204 within the frame process block 106 may, for example, enable generation of one or more speech hypotheses for the present speech frame. Each speech hypothesis may be based on a corresponding channel B data hypothesis and the channel A data. Speech data that may correspond to the present speech frame may then be selected from the speech hypotheses.

The frame process block 106 may enable comparison of each speech hypothesis to speech data from a previous speech frame to generate speech constraint metrics. The frame process block 106 may then select as the speech data a speech hypothesis that may closest to the previous speech frame based on the speech constraint metric. The speech constraint metric may comprise a measure of gain continuity and/or pitch continuity.

Various embodiments of the invention may also utilize, for example, a processor such as the processor 112 to control and/or directly process various functionalities described with respect to various embodiments of the invention. For example, the processor 112 may be involved in CRC calculation, generation of channel B data hypotheses, determination of whether channel B data may be acceptable, comparison of present speech hypotheses with previous speech data, and/or selection of present speech data.

Another embodiment of the invention may provide a machine-readable storage, having stored thereon, a computer program having at least one code section executable by a machine, thereby causing the machine to perform the steps as described herein for decoding WCDMA AMR speech data using redundancy.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for signal processing, the method comprising:
generating, within a receiver that receives voice data comprising at least a first channel data and a second channel data, if said first channel data passes verification and said second channel data is unacceptable based on one or more error measurement metrics, one or more second channel data hypotheses for a present speech frame;
generating one or more speech hypotheses for said present speech frame, wherein each of said one or more speech hypotheses is based on a corresponding one of said one or more second channel data hypotheses and said first channel data; and
selecting a present speech data from said one or more speech hypotheses.

2. The method according to claim 1, comprising comparing each of said one or more speech hypotheses to speech data from a previous speech frame to generate a speech constraint metric for each of said one or more speech hypotheses.

3. The method according to claim 2, comprising selecting as said speech data one of said one or more speech hypotheses that is closest to said previous speech frame based on said speech constraint metric.

4. The method according to claim 2, wherein said speech constraint metric comprises gain continuity.

5. The method according to claim 2, wherein said speech constraint metric comprises pitch continuity.

6. The method according to claim 1, wherein said one or more error measurement metrics comprise residual bit error rate.

7. The method according to claim 1, wherein said one or more error measurement metrics comprise a low Viterbi metric.

8. The method according to claim 1, wherein said verification is via cyclic redundancy check.

9. The method according to claim 1, wherein said first channel data comprise WCDMA channel A data.

10. The method according to claim 1, wherein said second channel data comprise WCDMA channel B data.

11. A machine-readable storage having stored thereon, a computer program having at least one code section for signal processing, the at least one code section being executable by a machine for causing the machine to perform steps comprising:
generating, within a receiver that receives voice data comprising at least a first channel data and a second channel data, if said first channel data passes verification and said second channel data is unacceptable based on one or more error measurement metrics, one or more second channel data hypotheses for a present speech frame;
generating one or more speech hypotheses for said present speech frame, wherein each of said one or more speech hypotheses is based on a corresponding one of said one or more second channel data hypotheses and said first channel data; and
selecting a present speech data from said one or more speech hypotheses.

12. The machine-readable storage according to claim 11, further comprising code for comparing each of said one or more speech hypotheses to speech data from a previous speech frame to generate a speech constraint metric for each of said one or more speech hypotheses.

13. The machine-readable storage according to claim 12, further comprising code for selecting as said speech data one of said one or more speech hypotheses that is closest to said previous speech frame based on said speech constraint metric.

14. The machine-readable storage according to claim 12, wherein said speech constraint metric comprises gain continuity.

15. The machine-readable storage according to claim 120, wherein said speech constraint metric comprises pitch continuity.

16. The machine-readable storage according to claim 11, wherein said one or more error measurement metrics comprise residual bit error rate.

17. The machine-readable storage according to claim 11, wherein said one or more error measurement metrics comprise a low Viterbi metric.

18. The machine-readable storage according to claim 11, wherein said verification is via cyclic redundancy check.

19. The machine-readable storage according to claim 11, wherein said first channel data comprise WCDMA channel A data.

20. The machine-readable storage according to claim 11, wherein said second channel data comprise WCDMA channel B data.

21. A system for signal processing, the system comprising:
one or more circuits, within a receiver that receives voice data comprising at least a first channel data and a second channel data, that enable generation of one or more second channel data hypotheses for a present speech frame, if said first channel data passes verification and said second channel data is unacceptable based on one or more error measurement metrics;
said one or more circuits enable generation of one or more speech hypotheses for said present speech frame, wherein each of said one or more speech hypotheses is based on a corresponding one of said one or more second channel data hypotheses and said first channel data; and
said one or more circuits enable selection of a present speech data from said one or more speech hypotheses.

22. The system according to claim 21, wherein said one or more circuits enable comparison of each of said one or more speech hypotheses to speech data from a previous speech frame to generate a speech constraint metric for each of said one or more speech hypotheses.

23. The system according to claim 22, wherein said one or more circuits enable selection as said speech data one of said one or more speech hypotheses that is closest to said previous speech frame based on said speech constraint metric.

24. The system according to claim 22, wherein said speech constraint metric comprises gain continuity.

25. The system according to claim 22, wherein said speech constraint metric comprises pitch continuity.

26. The system according to claim 21, wherein said one or more error measurement metrics comprise bit error rate.

27. The system according to claim 21, wherein said one or more error measurement metrics comprise a low Viterbi metric.

28. The system according to claim 21, wherein said verification is via cyclic redundancy check.

29. The system according to claim 21, wherein said first channel data comprise WCDMA channel A data.

30. The system according to claim 21, wherein said second channel data comprise WCDMA channel B data.
